(19) United States
(12) Patent Application Publication
(10) Pub. No.: US 2007/0189550 A1
(43) Pub. Date: Aug. 16, 2007

(54) Panel acoustic contributions examination

(76) Inventor: Sean F. Wu, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 11/354,214

(22) Filed: Feb. 14, 2006

(51) Int. Cl. H04B 15/00

(52) U.S. Cl. 381/94.1

(57) ABSTRACT

A system for analyzing noise sources correlates the sound pressure level value at any field point to the acoustic energy directly flowing out of any individual panel of a vibrating structure. This acoustic energy flow or acoustic intensity depicts how sound radiates and in which direction a sound wave propagates in the field. Therefore, the result represents a true contribution of an individual panel to an acoustic field. The acoustic intensity on the surface of a vibrating object is reconstructed by the Helmholtz equation least squares (HELS) based nearfield acoustical holography (NAH). The acoustic intensity is utilized to establish correlations between user-designated panels and the SPL value at any field point. With this information users can rank the order of contributions from individual panels of any vibrating structure to an acoustic field. These order ranking and panel contribution analyses help engineers to come up the best strategy to tackle various noise issues in the most cost-effective manner. The method is applicable to both interior and exterior regions.

### BACKGROUND OF INVENTION

This invention provides an accurate and cost-effective method to assess and analyze contributions of individual panels of a vibrating structure to the resultant sound pressure level (SPL) at any field point external to this structure. This method is applicable to both interior and exterior regions. It can have a significant impact on improving the accuracy and efficiency in analyzing noise transmission through a vibrating structure such as an aircraft cockpit or a vehicle passenger compartment. For example, noise inside a vehicle passenger compartment is generated by the engine, tires, powertrain, exhaust system, turbulent flow, etc., that are transmitted through various structure components such as an instrument panel, floor, ceiling and door. What an NVH (Noise Vibration and Harshness) engineer wants to know is the amount of acoustic energy that is transmitted through each structure component so as to develop the best strategy to reduce overall vehicle interior noise. Since the excitations and boundary conditions on any structure component are unknown, there is no way of predicting the vehicle interior noise analytically, not to mention identifying the contributions from individual structure components of a vehicle. The only way to examine contributions from various panels is through measurement. However, any measurement device such as a microphone measures the sum of the acoustic pressures radiated from all panels and does not assess the performance of individual panels so that vehicle noise can be reduced in a cost-effective manner.

Most current approaches to this problem are ad hoc or trial and error in nature. For example, one measures the transfer function between a possible cause (panel vibrations) and a receiver (driver ear position) to specify its correlation. This process is repeated for all panels, which is extremely labor intensive and time consuming. If such correlations are correctly established for each panel, then by measuring panel vibrations, one can predict the SPL values at driver ear position. Such a transfer path analysis (TPA) seems logical in the absence of more effective methodologies. The trouble with this approach is that success of TPA depends on the selection of the measurement point. If the location of the source responsible for sound radiation to the receiver is identified correctly and its strength is acquired, TPA analysis can yield meaningful results at the designated location. If the location of the source is not identified correctly, TPA result can be meaningless. Ironically, if the source location and strength can be specified, we do not need TPA. There are methodologies for predicting acoustic radiation anywhere, given the source information and boundary condition. In engineering applications, neither the source location nor its strength is known. So the first step in TPA is to locate the source, which is an open question. Furthermore, the TPA process must be repeated for every field point where correlation between sound and vibration is needed. Needless to say, the time and efforts required to establish these correlations can be prohibitive.

The demand is high on developing a more accurate and cost-effective methodology to analyze the transmission of acoustic energy through various structure components.

### SUMMARY OF INVENTION

The present invention correlates the SPL value at any field point to the acoustic energy directly flowing out of any individual panel of a vibrating structure. This acoustic energy flow or acoustic intensity depicts how sound radiates and in which direction a sound wave propagates in the field. Therefore, the result represents a true contribution of an individual panel to an acoustic field.

The acoustic intensity on the surface of a vibrating object is reconstructed by the Helmholtz equation least squares (HELS) based nearfield acoustical holography (NAH), as described in U.S. Pat. No. 5,712,805, which is hereby incorporated by reference in its entirety. HELS allows for reconstruction of all acoustic quantities such as the acoustic pressure, particle velocity, and acoustic intensity in 3D space, including a 3D source surface, based on the acoustic pressure measurements taken at very close range to the source surface. This method has been proven to be very cost effective in reconstruction of the acoustic field generated by an arbitrarily shaped structure. The acoustic intensity is utilized to establish correlations between user-designated panels and the SPL value at any field point.

With this information users can rank the order of contributions from individual panels of any vibrating structure to an acoustic field. These order ranking and panel contribution analyses help engineers to come up the best strategy to tackle various noise issues in the most cost-effective manner. The proposed method is applicable to both interior and exterior regions.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic of a system taking measurements near a noise source.

### DETAILED DESCRIPTION OF A PREFERRED EMBODIMENT

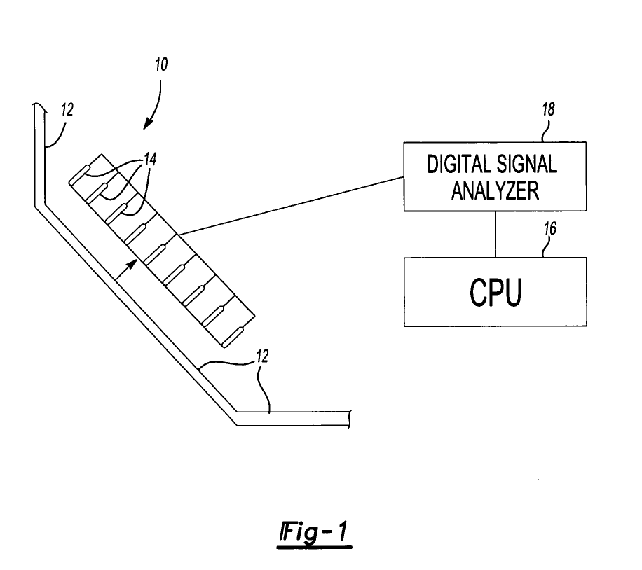

Referring to FIG. 1, the present invention provides a method and system 10 for analyzing the contribution noise from a plurality of panels 12. The system 10 includes a plurality of transducers 14, such as microphones, lasers, or the like, connected to a computer 16 via a sonic digitizer or digital signal analyzer 18. The computer 16 is programmed to perform the functions described herein, including the algorithms described below. The computer 16 includes a processor, memory, storage, display, input and output devices and any other necessary hardware. The transducers 16 are arranged in an array near at least one of the panels 12.

The previous methodology, such as TPA, utilizes the superposition principle, is valid for a linear, time-invariant system, and assumes that individual path contributions to the acoustic pressure pₘₙₗ(ω) at a field point m due to an excitation force Fₙₗ(ω) acting on the structure at point n in the ith direction can be written as
pₘₙₗ(ω)=Hₘₙₗ^{F}(ω)×Fₙₗ(ω), (1)

where Hₘₙₗ^{f}(ω) is the transfer function correlating Fₙₗ(ω) to pₘₙₗ(ω) and ω=2πf is the angular frequency. The idea behind Eq. (1) is that once the transfer function Hₘₙₗ^{F}(ω) is determined, then any change in the excitation Fₙₗ(ω) can be used to calculate the field acoustic pressure pₘₙₗ(ω). The trouble with this approach is that the direct impact of a force on a solid structure is structural deformation and vibration, not sound radiation. So there may not be a one-to-one correspondence between a force and sound. Consequently, a TPA based on force measurements will not yield the desired result.

An alternative is to measure the normal component of a surface velocity using an accelerometer, replace the excitation force Fₙₗ(ω) in Eq. (1) by the normal surface velocity Vₙₗ(ω), and identify the corresponding transfer function Hₘₙₗ^{V}(ω)). Once such a correlation is established, any change in the normal surface velocity may be used to predict the SPL value in the field. A trouble in this case is that although sound is produced by vibration, not all vibrations can generate sound. Thus, a TPA via measurements of the normal surface velocity is not the way to go.

Another variation of TPA is to measure an acoustic pressure next to a vibrating structure, replace Fₙₗ(ω) in Eq. (1) by the acoustic pressure pₙₗ(ω) and specify the corresponding transfer function Hₘₙₗ^{p}(ω). Once Hₘₙₗ^{p}(ω) is known, one can predict the field acoustic pressure based on a change in the measured pressures. This approach may be acceptable for predicting airborne sounds, but not for structure-borne sounds that cannot be properly described based on the knowledge of the acoustic pressure measurement alone.

A better approach is to use an intensity probe and measure the normal component of the acoustic intensity Iₙₗ(ω), replace Fₙₗ(ω) in Eq. (1) by Iₙₗ(ω) and find the corresponding transfer function Hₘₙₗ^{I}(ω). However, current technologies do not allow for measurements of the acoustic intensity on the surface of a structure, only at certain distance away from a source surface. This is because an intensity probe consists of a pair of phase-matched microphones that are separated by a spacer of a fixed length. The acoustic pressures measured at these microphones are used to approximate the particle velocity and acoustic pressure at the mid point of the spacer, which are subsequently used to calculate the acoustic intensity along the direction of the spacer. The physical dimensions of a microphone and spacer make it impossible to measure the normal component of the acoustic intensity on any surface. Since the acoustic intensity changes rapidly with distance, especially at high frequencies, the acoustic intensity measured in the field cannot be used to represent surface acoustic intensity.

This method seeks to establish a correlation between the normal component of surface acoustic intensity on an arbitrarily shaped panel of a vibrating structure and any field acoustic pressure. In particular, the normal surface acoustic intensity is reconstructed using HELS based NAH method but not measured. Consequently, the correlation signifies a true panel contribution to the acoustic pressure field.

The new formulations are derived from the definition of SPL directly

$${L}_{p} ( {\vec{x}}_{l} ) = 10 log [ \frac{{p}_{av}^{2} ( {\vec{x}}_{l} )}{{p}_{ref}^{2}} ] , \qquad ( 2 )$$

where Lₚ(\vec{x}ₗ) indicates the SPL value at any field point \vec{x}ₗ, pₐᵥ²(\vec{x}ₗ) is the mean-squared acoustic pressure at any field point \vec{x}ₗ, and p_{ref}=20 (μPa) is the reference pressure. Assuming a constant frequency for which the acoustic pressure is expressible as a complex amplitude \hat{p}(\vec{x}ₗ) multiplied by a time harmonic function e^{-iωl}, we can rewrite the mean-squared acoustic pressure pₐᵥ²(\vec{x}ₗ) in Eq. (2) as

$${p}_{av}^{2} ( {\vec{x}}_{l} ) = \frac{1}{2} Re ( \hat{p} ( {\vec{x}}_{l} ) {\hat{p}}^{*} ( {\vec{x}}_{l} ) ) , \qquad ( 3 )$$

where a superscript * indicates a complex conjugation.

Note that the complex amplitude of the acoustic pressure \hat{p}(\vec{x}ₗ) at \vec{x}ₗ can be related to that of the acoustic pressure at any other point using the HELS formulation³
\hat{p}(\vec{x}ₗ)=Gₚₚ(\vec{x}ₗ|\vec{x}ₛ)_{1×N}\hat{p}(\vec{x}ₛ)_{N×l}, (4)

where Gₚₚ(\vec{x}ₗ|\vec{x}ₛ)_{1×N} implies the pressure-to-pressure transfer function that correlate the acoustic pressure \hat{p}(\vec{x}ₗ) at \vec{x}ₗ to a column vector of the acoustic pressure \hat{p}(\vec{x}ₛ) on the source surface \vec{x}ₛ, s=1, 2, . . . , N, where N is the total number of points distributed on the entire source surface.
Gₚₚ(\vec{x}ₗ|\vec{x}ₛ)_{1×N}=Ψ(\vec{x}ₗ)_{1×J}_{ₒₚ}Ψ(\vec{x}ₛ)_{N×J}_{ₒₚ}^{†}, (5)
where Ψ(\vec{x}ₗ;ω)_{1×J}_{ₒₚ} represents a vector whose elements are given by
Ψₙₘ(rₗ,θₗ,φₗ)=hₙ^{(l)}(krₗ)Yₙ^{m}(θₗ, φₗ), (6)
where hₙ^{(l)}(krₗ) stands for the spherical Hankel function of the first kind, Yₙ^{m}(θₗ,φₗ) represents the spherical harmonics, (rₗ,θₗ,φₗ) are the spherical coordinates, and Jₒₚ implies the optimal number of expansion that can be obtained by minimizing residues in reconstructing the acoustic pressure on the measurement surface with respect to the measured data.³ Note that the reason for selecting the spherical coordinates is for convenience since the spherical Hankel hₙ^{(l)}(krₗ) and the spherical harmonics Yₙ^{m}(θₗ,φₗ) are readily available in any commercial software. The symbol Ψ(\vec{x}ₛ)_{N×J}_{ₒₚ} in Eq. (5) represents a pseudo inversion of Ψ(\vec{x}ₛ)_{N×J}_{ₒₚ} that is evaluated on the surface \vec{x}ₛ,
Ψ(\vec{x}ₛ)_{N×J}_{ₒₚ}^{†}=(Ψ(\vec{x}ₛ)_{N×J}_{ₒₚ}^{T}Ψ(\vec{x}ₛ)_{N×J}_{ₒₚ})⁻¹Ψ(\vec{x}ₛ)_{N×J}_{ₒₚ}^{T}, (7)
where a superscription T indicates a matrix transposition, Ψ(\vec{x}ₛ)_{N×J}_{ₒₚ} contains the same elements as Ψ(\vec{x}ₗ)_{1×N} does, except that they are evaluated on a source surface. Similarly, we can relate the acoustic pressure \hat{p}(\vec{x}ₗ) at \vec{x}ₗ to a column vector of the normal surface velocity \hat{v}ᵥ(\vec{x}ₛ) at \vec{x}ₛ,
\hat{p}(\vec{x}ₗ)=Gₚᵥ (\vec{x}ₗ|\vec{x}ₛ)_{1×N}\hat{V}ᵥ(\vec{x}ₛ)_{N×l}, (8)
where Gₚᵥ(\vec{x}ₗ|\vec{x}ₛ)_{1×N} is a pressure-to-velocity transfer function correlating \hat{p}(\vec{x}ₗ) to \hat{v}(\vec{x}ₛ),

$${{G}_{pv} ( {\vec{x}}_{l} \text{\vert} {\vec{x}}_{s} )}_{1 \times N} = \frac{1}{ⅈ ω {ρ}_{0}} \frac{\partial {Ψ ( {\vec{x}}_{l} )}_{1 \times {J}_{op}}}{\partial v} {Ψ ( {\vec{x}}_{s} )}_{N \times {J}_{op}}^{†} , \qquad ( 9 )$$

where ρ₀ is the density of the air and v is in the direction of a unit normal vector on the surface. Substituting \hat{p}(\vec{x}ₗ) in Eq. (4) and the complex conjugate of \hat{p}(\vec{x}ₗ) given by Eq. (8) to (3) yields,
pₐᵥ²(\vec{x}ₗ)=Re(Gₚₚ(\vec{x}ₗ|\vec{x}ₛ)_{1×N}Îᵥ(\vec{x}ₛ)_{N×N}Gₚᵥ(\vec{x}ₗ|\vec{x}ₛ)_{1×N}^{†}), (10)
where Îᵥ(\vec{x}ₛ)_{N×N} represents the time-averaged normal surface acoustic intensity matrix,

$${{\hat{I}}_{v} ( {\vec{x}}_{s} )}_{N \times N} = \frac{1}{2} Re ( {\hat{p} ( {\vec{x}}_{s} )}_{N \times 1} {{\hat{v}}_{v} ( {\vec{x}}_{s} )}_{N \times 1}^{†} ) . \qquad ( 11 )$$

To conduct panel contribution analyses, we rewrite Eq. (10) in terms of the sum of contributions from individual panels. Suppose that the entire structure surface is divided into Nᵤ segments from which contributions of acoustic energy flows to the field acoustic pressure \hat{p}(\vec{x}ₗ) are desired.

$${p}_{av}^{2} ( {\vec{x}}_{l} ) = {\sum }_{μ = 1}^{u} {\hat{P}}_{{N}_{μ}} ( {\vec{x}}_{l} \text{\vert} {\vec{x}}_{s} ) , \qquad ( 12 )$$

where \hat{P}_{N}_{_{μ}}(\vec{x}ₗ|\vec{x}ₛ) represents the acoustic energy flow from the uLth surface segment to the field,
\hat{P}_{N}_{_{μ}}(\vec{x}ₗ|\vec{x}ₛ)=Re(Gₚₚ(\vec{x}ₗ|\vec{x}ₛ)_{1×N}_{_{μ}}Îᵥ(\vec{x}ₛ)_{N}_{_{μ}}_{×N}_{_{μ}}Gₚᵥ(\vec{x}ₗ|\vec{x}ₛ)_{1×N}_{_{μ}}^{†}), (13)
where Gₚₚ(\vec{x}ₗ|\vec{x}ₛ)_{1×N}_{_{μ}} is the same transfer function as Gₚₚ(\vec{x}ₗ|\vec{x}ₛ)_{1×N} given by Eq. (5), except it is with respect to individual panels, and the index N_{μ} indicates the number of surface points on the μth segment, μ=1, 2, . . . , u. Similarly, Gₚᵥ(\vec{x}ₗ|\vec{x}ₛ)_{1×N}_{_{μ}}^{†} is the pseudo inversion of Gₚᵥ(\vec{x}ₗ|\vec{x}ₛi)_{1×N}_{_{μ}}, which is the same as Gₚᵥ(\vec{x}ₗ|\vec{x}ₛ)_{1×N} defined in Eq. (9), while Îᵥ(\vec{x}ₛ)_{N}_{_{μ}}_{×N}_{_{μ}} is the same as Îᵥ(\vec{x}ₛ)_{N×N} given by Eq. (11) and both of them are with respect to individual panels. Note that the sum of the points on all individual panels should be equal to the total number of surface points.

$$N = {\sum }_{μ = 1}^{u} {N}_{μ} . \qquad ( 14 )$$

Substituting Eq. (12) to (2) yields,

$${L}_{p} ( {\vec{x}}_{l} ) = 10 log [ {\sum }_{μ = 1}^{u} \frac{Re ( {{G}_{pp} ( {\vec{x}}_{l} \text{\vert} {\vec{x}}_{s} )}_{1 \times {N}_{μ}} {{\hat{I}}_{v} ( {\vec{x}}_{s} )}_{{N}_{μ} \times {N}_{μ}} {{G}_{pv} ( {\vec{x}}_{l} \text{\vert} {\vec{x}}_{s} )}_{1 \times {N}_{μ}}^{†} )}{{p}_{ref}^{2}} ] . \qquad ( 15 )$$

Equation (15) correlates the normal components of time-averaged acoustic intensities on individual panel surfaces of a vibrating structure to acoustic pressure anywhere in the field. Note that the normal surface acoustic intensities are reconstructed but not measured. This is accomplished using HELS based NAH that yields the acoustic pressure \hat{p}(\vec{x}ₛ) and normal component of velocity \hat{v}ᵥ(\vec{x}ₛ) on a 3D source surface via the acoustic pressure \hat{p}(\vec{x}ₘ) measured at very close range to the source surface.

$$\begin{matrix}{\hat{p} ( {\vec{x}}_{s} )}_{N \times 1} = {Ψ ( {\vec{x}}_{s} )}_{N \times {J}_{op}} {Ψ ( {\vec{x}}_{m} )}_{M \times {J}_{op}}^{†} {\hat{p} ( {\vec{x}}_{m} )}_{M \times 1} , & ( 16 a ) \\ {{\hat{v}}_{v} ( {\vec{x}}_{s} )}_{N \times 1} = \frac{1}{ⅈ ω {ρ}_{0}} \frac{\partial {Ψ ( {\vec{x}}_{s} )}_{N \times {J}_{op}}}{\partial v} {Ψ ( {\vec{x}}_{m} )}_{M \times {J}_{op}}^{†} {\hat{p} ( {\vec{x}}_{m} )}_{M \times 1} , & ( 16 a )\end{matrix}$$

where \hat{p}(\vec{x}ₘ)_{M×I} implies a column vector of the acoustic pressures at \vec{x}ₘ, m =1, . . . , M , which are measured at a close proximity to the source surface.

The major advantages of the system 10 is that 1) it provides a direct correlation between the acoustic energy flow out of any panel of a vibrating structure to a field point; 2) it is valid for field points in both inside and outside regions; 3) it enables one to rank the order of contributions from individual panels of a structure to the SPL values anywhere in the field; 4) measurements of the acoustic pressure need be taken only once for a panel contribution analysis of all field points; and 5) the accuracy and efficiency of the order ranking and panel contribution analysis are much higher than those of TPA based analyses.

### PROCEDURES

Consider a vibrating structure such as an automobile that is generating noise in both exterior and interior regions. Suppose that the structure vibrates at a constant frequency such that the acoustic pressure is expressible as the real part of a complex amplitude of the acoustic pressure multiplied by a time harmonic function e^{-iωt}. Our goal is to identify the contributions of individual structure panels to the radiated acoustic pressure fields in both exterior and interior regions accurately and efficiently. To this end, we will utilize the proposed technology described above. The procedures involved in this new approach are as follows.

1. Design an array of microphones 14 that are form-fitted to the contour of the structure surface 12 under consideration. Such a conformal array may be easily and quickly made by using ¼″ copper tubing that is very flexible but strong to hold several microphones 14. The reason for using a conformal array is to ensure uniformity in measurement distance and consistence in the measurement accuracy.

2. Use a sonic digitizer 18 to get the coordinates of each measurement microphone 14 and transfer the data to a PC 16 that controls the data acquisition process.

3. Use this conformal array of microphones 14 to measure the acoustic pressures at a very close distance to the structure 12. If the structure is big, a number of patches of measurements may be made in order to cover the entire structure surface.

4. Measured the acoustic pressure \hat{p}(\vec{x}ₘ)_{M×I} and determine the optimal number of expansion Jₒₚ. Establish the matrices Ψ(\vec{x}ₛ)_{N×J}_{ₒₚ} and Ψ(\vec{x}ₘ)_{N×J}_{ₒₚ} ^{†} that are evaluated on source surface \vec{x}ₛ, s=1, 2, . . . , N, and in the field \vec{x}ₘ, m=1, . . . , M, respectively.

5. Substitute Ψ(\vec{x}ₛ)_{N×J}_{ₒₚ}, Ψ(\vec{x}ₘ)_{N×J}_{ₒₚ} ^{†}, and \hat{p}(\vec{x}ₘ)_{M×I} into Eq. (16) to reconstruct the acoustic pressure \hat{p}(\vec{x}ₛ) and the normal component of the velocity \hat{v}ᵥ(\vec{x}ₛ) on the source surface.

6. Substitute \hat{p}(\vec{x}ₛ) and \hat{v}ᵥ(\vec{x}ₛ) into Eq. (11) to reconstruct the normal component of time-averaged acoustic intensity Îᵥ(\vec{x}ₛ)_{N×N} on the source surface.

7. Create the pressure-to-pressure transfer function Gₚₚ(\vec{x}ₗ|\vec{x}ₛ)_{1×N} that correlates the surface acoustic pressure \hat{p}(\vec{x}ₛ) to the designated field acoustic pressure \hat{p}(\vec{x}ₗ) using Eq. (5).

8. Create the pressure-to-velocity transfer function Gₚᵥ(\vec{x}ₗ|\vec{x}ₛ)_{1×N} that correlates the normal surface velocity \hat{v}ᵥ(\vec{x}ₛ) to the designated field acoustic pressure \hat{p}(\vec{x}ₗ) using Eq. (9).

9. Divide Gₚₚ(\vec{x}ₗ|\vec{x}ₛ)_{1×N}, Gₚᵥ(\vec{x}ₗ|\vec{x}ₛ)_{1×N} and Îᵥ(\vec{x}ₛ)_{N×N} into individual components that cover N_{μ} panel surfaces from which acoustic contributions to the designated field point are to be analyzed. Use Eq. (13) to determine the amplitude and phase of the acoustic energy flow \hat{P}_{μ}(\vec{x}ₗ|\vec{x}ₛ) from each panel. The sum of the amplitudes and phases of \hat{P}_{μ}(\vec{e}ₗ|\vec{x}ₛ) from all N_{μ} panels should be equal to those of the mean-square averaged acoustic pressure \hat{p}ₐᵥ²(\vec{x}ₗ).

10. Plot amplitudes and phases of \hat{P}_{μ}(\vec{x}ₗ|\vec{x}ₛ), u=1, 2, . . . , u, which correspond to contribution from each individual panel surface of a vibrating structure to the field point \vec{x}ₗ.

11. Rank the order of contributions of individual panel surfaces to the SPL value at \vec{x}ₗ.

12. Repeat Steps 7 to 11 to complete the order ranking and panel contribution analyses for all field points required.

To demonstrate the effectiveness of the system 10 in analyzing panel contributions to any field acoustic pressure, an experiment was conducted on a full-size Sports Utility Vehicle (SUV), which was mounted on four dynamometers and run at different speeds under a loaded condition. To analyze noise transmission into this SUV, a conformal array of thirty-six microphones 14 was set up and twenty-five patches of measurements of the acoustic pressure were taken at a distance of 1.5 cm from the vehicle interior surface. These data were used to reconstruct the surface acoustic pressure and the normal component of surface velocity, which were then used to calculate the normal component of time-averaged acoustic intensity on the surface. Once this was done, the correlations between surface normal intensities and field acoustic pressures were established. To validate the results obtained, the reconstructed acoustic pressures at the driver ear, front passenger ear, rear left passenger ear, and rear right passenger ear positions were compared with those measured at the same locations.

Once the surface acoustic pressure and normal surface velocity are specified, we can reconstruct the field acoustic pressure anywhere inside the SUV compartment. To examine the accuracy of the present algorithm, we measure the acoustic pressures and compare them to the reconstructed acoustic pressures at the same locations. The measured acoustic pressure spectra at driver ear, front passenger ear, rear left passenger ear, and rear right passenger ear positions are then compared with the reconstructed ones.

In one example of order ranking and panel contribution analysis, ten panels were selected that are located on the floor (driver side, middle, passenger side), in the lift gate (driver side 1, driver side 2, middle 1, middle 2, passenger side 1, passenger side 2), and jack storage area. The noise spectrum measured at the driver ear position was examined to identify the top 11 peaks that are centered at 104, 116, 122, 177, 180, 191, 197, 235, 241, 255, and 258 Hz, respectively. The order of contributions of the acoustic energy flow from the selected ten panels to the SPL value at the driver ear position can be ranked.

Using Eq. (12), it is easy to determine the relative contributions from these panels and rank their orders at all peaks. The panels that contribute most to the SPL value at the driver ear position and their order ranking at 104, 116, and 235 Hz, respectively, are identified. Results show that the jack storage area contributed the most to the SPL value at 104 Hz, a middle floor panel was the major contributor to the SPL value at 116 Hz, while the middle lift gate panel was found to contribute the most to the SPL value at the driver ear position at 235 Hz.

The same procedures can be repeated for the passenger ear position or anywhere inside the SUV. Since this analysis can be repeated without retaking the measurements of acoustic pressures, the efficiency of the panel contribution analysis is significantly enhanced. Most importantly, the system 10 provides a direct correlation of acoustic energy flow from any designated panel surface to a field point, so the accuracy of panel contribution analysis is very high and reliable.

What is claimed is:

1. A method for analyzing noise including the steps of:
measuring acoustic pressure at a plurality of locations near a noise source;
reconstructing a surface acoustic pressure and a normal surface velocity on a source surface of the noise source based upon the measured acoustic pressures at the plurality of locations;
reconstructing a normal component of acoustic intensity on the source;
creating a pressure-to-pressure transfer function that correlates the surface acoustic pressure to field acoustic pressure; and
creating a pressure-to-velocity transfer function that correlates the normal surface velocity to the field acoustic pressure.

2. The method of claim 1 further including the step of dividing the pressure-to-pressure transfer function and the pressure-to-velocity transfer function into individual components that cover a plurality of panel surfaces of the noise source.

3. The method of claim 2 further including the step of comparing amplitudes and phases of contributions from each of the plurality of panel surfaces to noise at a designated point.

4. The method of claim 3 further including the step of ranking the contributions from each of the plurality of panel surfaces.

5. A system for diagnosing noise comprising:
a plurality of microphones for measuring acoustic pressure at a plurality of locations;
a processor receiving signals from the plurality of microphones indicative of the acoustic pressure at the plurality of locations, the processor programmed to reconstruct a surface acoustic pressure and a normal surface velocity on a source surface of the noise source based upon the measured acoustic pressures at the plurality of locations, the processor programmed to reconstruct a normal component of acoustic intensity on the source, the processor programmed to create a pressure-to-pressure transfer function that correlates the surface acoustic pressure to field acoustic pressure, the processor programmed to create a pressure-to-velocity transfer function that correlates the normal surface velocity to the field acoustic pressure.

6. A method for analyzing noise including the steps of:
measuring acoustic pressure at a plurality of locations near each of a plurality of noise source panels;
for each of the plurality of noise source panels, reconstructing a surface acoustic pressure and a normal surface velocity on a source surface of the noise source based upon the measured acoustic pressures at the plurality of locations and reconstructing a normal component of acoustic intensity on the source; and
comparing a noise contribution from the plurality of noise source panels at a selected field point.

7. The method of claim 6 further including the step of comparing amplitudes and phases of the noise contributions from the plurality of noise source panels.

8. The method of claim 7 further including the step of ranking the contributions from the plurality of noise source panels.
